(19) United States
(12) Patent Application Publication
(10) Pub. No.: US 2011/0113746 A1
(43) Pub. Date: May 19, 2011

(54) GRASS TRIMMING DEVICE WITH A FRONT GUARD

(76) Inventor: Paul Lin, Tainan Hsien (TW)

(21) Appl. No.: 12/772,336

(22) Filed: May 3, 2010

(30) Foreign Application Priority Data
Nov. 18, 2009 (TW) 098139113

(51) Int. Cl. A01D 67/00

(52) U.S. Cl. 56/320.1

(57) ABSTRACT

A grass trimming device includes a handle, a drive shaft driven by a drive unit and rotatably mounted on a cutting head-mounting end of the handle to swing a grass cutting member which extends radially from the cutting head-mounting end, and a safety shield mounted on the cutting head-mounting end, and having a shielding major wall which extends radially to shield a circumferential sweeping area of the cutting member, and which terminates at a peripheral marginal region. The shielding major wall has a cutout section extending from the peripheral marginal region radially and inwardly to terminate at a bordering edge. A guard unit extends cantileveredly from the bordering edge and radially and outwardly of the circumferential sweeping area so as to guard the cutting member against getting closer to undesired object.

### BACKGROUND OF THE INVENTION

1. Field of the Invention

This invention relates to a grass trimming device, more particularly to a handheld grass trimming device with a front guard for protecting a grass cutting member thereof from getting closer to an undesired object.

2. Description of the Related Art

A conventional handheld grass trimming device used to trim grass in uneven areas with higher and rougher grass generally includes an elongated handle having a handgrip end and a motor-mounting end, a motor mounted in the motor-mounting end, a grass cutting member is connected to and driven by the motor to rotate, and a guard detachably mounted on the motor-mounting end and configured to shield a rear part of the grass cutting member so as to prevent debris of weed and grass from flying toward the user. A front part of the grass cutting member may be exposed for cutting the grass on an obstructed area, such as a wall corner or a trench side. However, when the grass cutting member is needed to get closer to a wall for cutting the grass near the wall corner, it would happen quite often that the user may accidentally hit the grass cutting member against the wall to result in damage to a cutting edge of the cutting member.

### SUMMARY OF THE INVENTION

An object of the present invention is to provide a grass trimming device which has means for guarding a grass cutting member thereof against getting closer to an undesired object during usage.

According to this invention, the grass trimming device includes a handle extending in a lengthwise direction to terminate at a handgrip end and a cutting head-mounting end, a drive shaft adapted to be driven by a drive unit, and rotatably mounted on the cutting head-mounting end about a revolving axis, a grass cutting member extending radially from the cutting head-mounting end, and swung by the drive shaft to define a circumferential sweeping area, and a safety shield mounted on the cutting head-mounting end, and having a shielding major wall which extends radially to shield the circumferential sweeping area, and which terminates at a peripheral marginal region. The shielding major wall has a cutout section extending from the peripheral marginal region radially and inwardly to terminate at a bordering edge. The grass trimming device further includes a guard unit extending cantileveredly from the bordering edge radially and outwardly of the circumferential sweeping area so as to guard the grass cutting member against getting closer to undesired object.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of the preferred embodiment of a grass trimming device according to this invention;

FIG. 2 is a fragmentary perspective view of a portion of the preferred embodiment; and

FIG. 3 is a fragmentary side view of the portion of the preferred embodiment.

### DETAILED DESCRIPTION OF THE PREFERRED EMBODIMENT

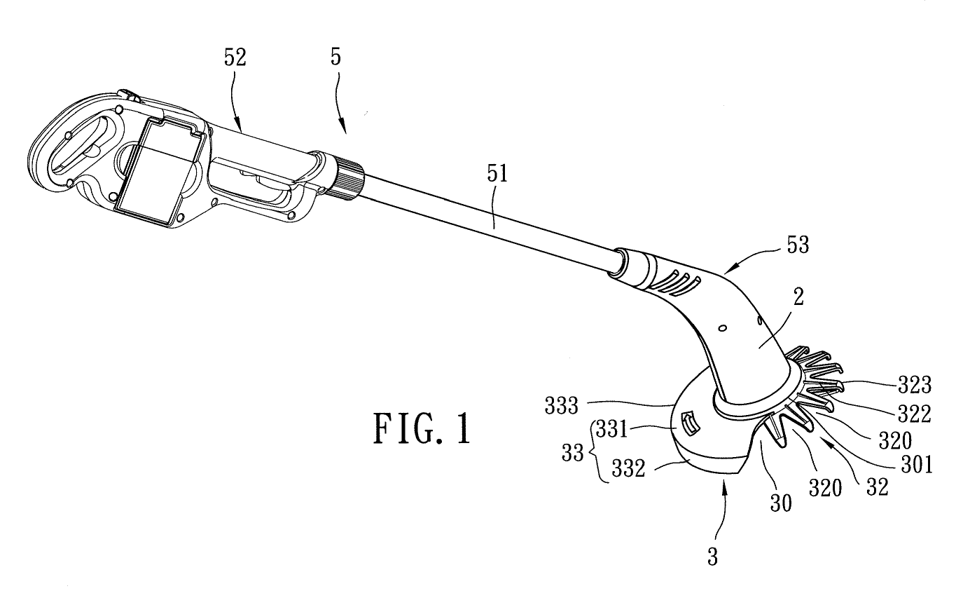

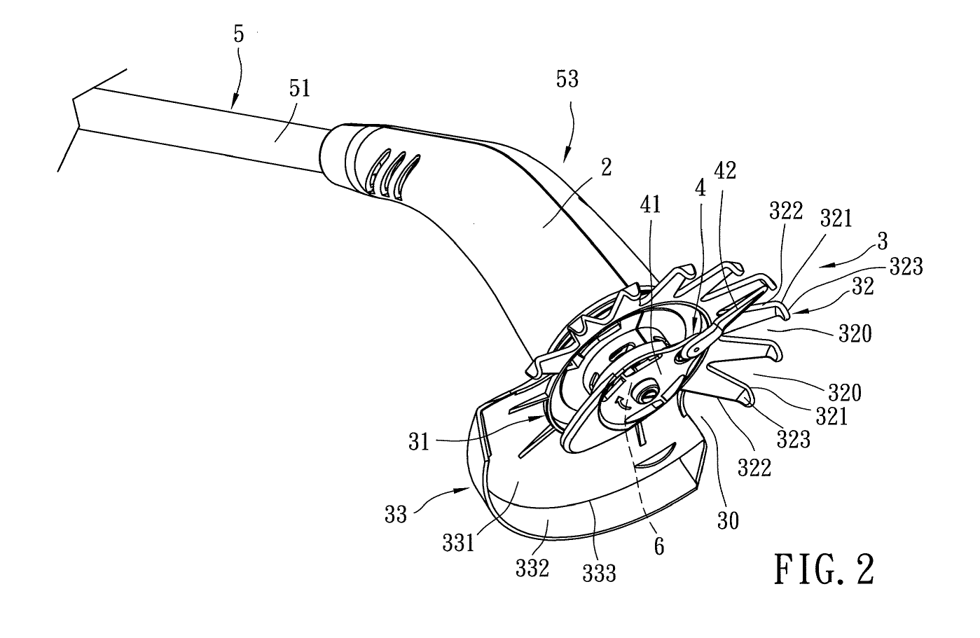

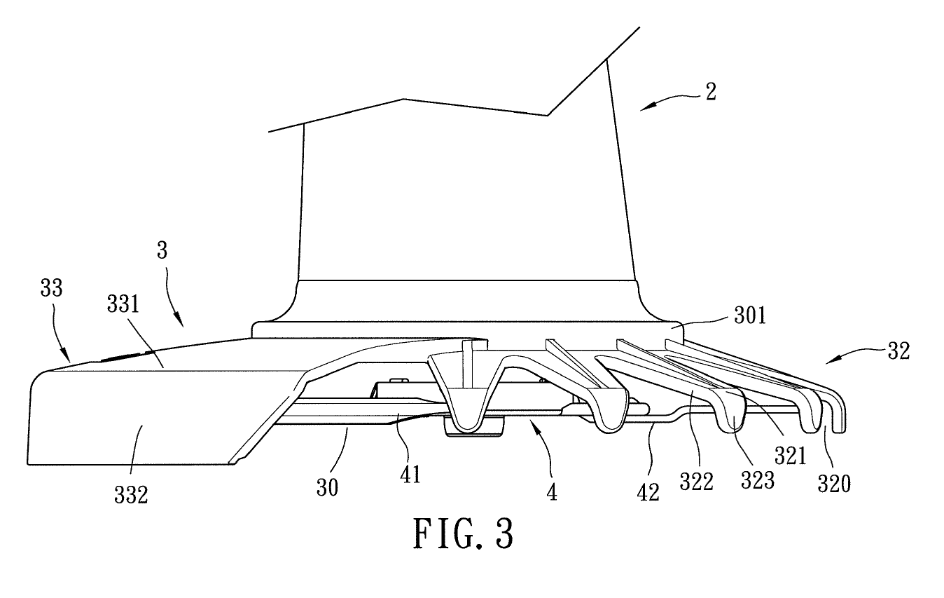

Referring to FIGS. 1 to 3, the preferred embodiment of a grass trimming device according to the present invention is shown to comprise a handle 5, a drive shaft 6, a grass cutting member 4, a safety shield 33, and a guard unit 32.

The handle 5 extends in a lengthwise direction to terminate at a handgrip end 52 and a cutting head-mounting end 53. The cutting head-mounting end 53 has amounting seat 2 disposed thereon for mounting a driving unit (not shown), such as a motor. The drive shaft 6 is driven by the drive unit, and is rotatably mounted on the mounting seat 2 about a revolving axis. The grass cutting member 4 has a rotating hub 41 disposed to be rotated with the drive shaft 6 about the revolving axis, and a cutting blade 42 extending radially relative to the revolving axis from the rotating hub 41 so as to be swung by the drive shaft 6, thereby defining a circumferential sweeping area. The safety shield 33 is mounted on the mounting seat 2, and has a shielding major wall 331 which extends radially relative to the revolving axis to shield the circumferential sweeping area, and which terminates at a peripheral marginal region 333, and a skirt portion 332 extending axially and downwardly from the peripheral marginal region 333 to further prevent cut grass from flying out of the circumferential sweeping area. The shielding major wall 331 has a cutout section 30 that extends from the peripheral marginal region 333 radially and inwardly to terminate at a bordering edge 301 so as to permit a user to view swinging action of the grass cutting member 4.

The guard unit 32 extends cantileveredly from the bordering edge 301 radially and outwardly of the circumferential sweeping area of the grass cutting member 4 so as to guard the grass cutting member 4 against getting closer to undesired object. In this embodiment, the guard unit 32 includes a plurality of guard fins 322 which extend radially and outwardly from the bordering edge 301 to terminate at a plurality of cantilevered fin ends 321, and each of which is angularly displaced from an adjacent one of the guard fins 322 by a radial gap spacing 320. The guard unit 32 further includes a plurality of tabs 323, each of which extends downwardly from a respective one of the cantilevered fin ends 321 to serve as a front guard for the circumferential sweeping area of the grass cutting member 4. Preferably, the guard unit 32 is integrally formed with the bordering edge 301 of the safety shield 33 to serve as a guard structure 3.

As illustrated, the grass cutting member 4 can be guarded by the guard unit 32 against getting closer to an undesired object, such as a wall corner or a trench side, so that the service life of the grass cutting member 4 is prolonged. In addition, by virtue of the radial gap spacings 320, the grass in front of the guard unit 32 can be entrapped into the cutout section 30 for being cut by the grass cutting member 4. Moreover, when the grass trimming device of this invention is not in use, the cutting head-mounting end 53 can be disposed in a standing position by resting the skirt portion 332 and the tabs 323 on the ground for shielding the cutting blade 42.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A grass trimming device comprising:
a handle extending in a lengthwise direction to terminate at a handgrip end and a cutting head-mounting end;
a drive shaft adapted to be driven by a drive unit, and rotatably mounted on said cutting head-mounting end about a revolving axis;
a grass cutting member which extends radially relative to the revolving axis from said cutting head-mounting end, and which is swung by said drive shaft so as to define a circumferential sweeping area;
a safety shield mounted on said cutting head-mounting end, and having a shielding major wall which extends radially relative to the revolving axis to shield said circumferential sweeping area, and which terminates at a peripheral marginal region, said shielding major wall having a cutout section that extends from said peripheral marginal region radially and inwardly to terminate at a bordering edge so as to permit a user to view swinging action of said grass cutting member; and
a guard unit extending cantileveredly from said bordering edge and radially and outwardly of said circumferential sweeping area so as to guard said grass cutting member against getting closer to undesired object.

2. The grass trimming device according to claim 1, wherein said guard unit includes a plurality of guard fins which extend radially and outwardly from said bordering edge to terminate at a plurality of cantilevered fin ends, and which are angularly displaced from each other by a radial gap spacing to entrap the grass that is to be cut by said grass cutting member.

3. The grass trimming device according to claim 2, wherein said guard unit further includes a plurality of tabs each extending downwardly from a respective one of said cantilevered fin ends so as to serve as a front guard for said circumferential sweeping area.

4. The grass trimming device according to claim 1, wherein said guard unit is integrally formed with said bordering edge of said safety shield.

5. The grass trimming device according to claim 1, wherein said safety shield has a skirt portion which is disposed at the radially opposite side of the revolving axis relative to said cutout section and which extends axially and downwardly from said peripheral marginal region to prevent cut grass from flying out of said circumferential sweeping area.
